(19) United States
(12) Patent Application Publication
(10) Pub. No.: US 2007/0236861 A1
(43) Pub. Date: Oct. 11, 2007

(54) IMPLANTABLE CO-FIRED ELECTRICAL FEEDTHROUGHS

(76) Inventors: Jeremy W. Burdon, Minneapolis, MN (US); Joyce K. Yamamoto, Maple Grove, MN (US); Lea A. Nygren, Bloomington, MN (US); William D. Wolf, St. Louis Park, MN (US)

Correspondence Address: MEDTRONIC, INC., 710 MEDTRONIC PARKWAY NE, MINNEAPOLIS, MN, 55432-9924, US

(21) Appl. No.: 11/278,773

(22) Filed: Apr. 5, 2006

(51) Int. Cl. H01G 4/35

(52) U.S. Cl. 361/302

(57) ABSTRACT

A hermetic interconnect for implantable medical devices is presented. In one embodiment, the hermetic interconnect includes a conductive material introduced to a via in a single layer. The conductive material includes a first end and a second end. A first bonding pad is coupled to the first end of the conductive material. A second bonding pad is coupled to the second end of the conductive material. The single layer and the conductive material undergo a co-firing process.

### CROSS REFERENCE TO RELATED APPLICATIONS

This application is related to, and claims the benefit of, U.S. patent application Ser. No. 11/227342 (Attorney Docket No. P21242.00) filed on Sep. 15, 2005 and entitled, “IMPLANTABLE CO-FIRED ELECTRICAL FEEDTHROUGHS ”, which is incorporated herein by reference in its entirety.

This application is a continuation-in-part of application serial number. This application is also related to U.S. patent application Ser. No. 11/227,375 (Attorney Docket No. P-21241.00) filed on Sep. 15, 2005 and entitled, “MINIATURIZED CO-FIRED ELECTRICAL INTERCONNECTS FOR IMPLANTABLE MEDICAL DEVICES,” U.S. patent application Ser. No. 11/227,523 (Attorney Docket No. P-21241.01) filed on Sep. 15, 2005 and entitled, “MULTI-PATH, MONO-POLAR CO-FIRED HERMETIC ELECTRICAL FEEDTHROUGHS AND METHODS OF FABRICATION THEREFOR”, and U.S. patent application Ser. No. 11/227,341 (Attorney Docket No. P-22315.00) filed on Sep. 15, 2005 and entitled, “IMPLANTABLE CO-FIRED ELECTRICAL INTERCONNECT SYSTEMS AND DEVICES AND METHODS OF FABRICATION THEREFOR”, each of which is hereby incorporated by reference herein.

### FIELD

The present invention relates generally to implantable medical devices (IMDs) and, more particularly, to hermetic interconnects associated with IMDs.

### BACKGROUND

Implantable medical devices (IMDs) detect and deliver therapy for a variety of medical conditions in patients. IMDs include implantable pulse generators (IPGs) or implantable cardioverter-defibrillators (ICDs) that deliver electrical stimuli to tissue of a patient. ICDs typically comprise, inter alia, a control module, a capacitor, and a battery that are housed in a hermetically sealed container. When therapy is required by a patient, the control module signals the battery to charge the capacitor, which in turn discharges electrical stimuli through at least one lead extending from the ICD to tissue of a patient.

The lead is connected to the ICD through a feedthrough. Feedthroughs typically include a wire, an insulator member, and a ferrule. The wire extends through the insulator member. The insulator member is then seated in the ferrule. It is desirable to increase the performance of ICDs by improving feedthroughs.

### BRIEF DESCRIPTION OF THE DRAWINGS

FIG. 1 depicts a cross-sectional view of a co-fired five layered hermetic interconnect;

FIG. 2 depicts a cross-sectional view of a co-fired three layered hermetic interconnect seated in a ferrule;

FIG. 3A depicts a cross-sectional view of a co-fired three layered hermetic interconnect;

FIG. 3B is a magnified view of the circular area indicated in FIG. 3A showing the relative relationship between the co-fired-ceramic three layered hermetic interconnect and an underlying support member due to diffusion bonding;

FIG. 4 depicts a cross-sectional view of a co-fired three layered hermetic interconnect with depiction of a thin-film reactive interlayer material, and a ferrule structure prior to stacking, assembly and diffusion-bonding;

FIG. 5 depicts a cross-sectional view of a co-fired five layered hermetic interconnect;

FIG. 6 depicts a cross-sectional view of a co-fired three layered hermetic coupled to a ferrule;

FIG. 7 depicts a cross-sectional view of a co-fired three layered using diffusion-bonding and including a direct ground connection to a conductive ferrule member;

FIG. 8 is a cross-sectional view of another embodiment of a hermetic interconnect for an implantable medical device;

FIG. 9 is a cross-sectional view of yet another embodiment of a hermetic interconnect for an implantable medical device; and

FIG. 10 is a cross-sectional view of still yet another embodiment of a hermetic interconnect for an implantable medical device.

### DETAILED DESCRIPTION

The following description of an embodiment is merely exemplary in nature and is in no way intended to limit the invention, its application, or uses. For purposes of clarity, the same reference numbers are used in the drawings to identify similar elements.

The present invention is directed to a hermetic interconnect for an implantable medical device (IMD). In one embodiment, the hermetic interconnect includes conductive material introduced to a via in a single layer. The conductive material includes a first end and a second end. A first bonding pad is coupled to the first end and a second bonding pad is coupled to the second end of the conductive material. The single layer and the conductive material undergo a co-firing process. The co-firing process includes low-temperature co-fired ceramic (LTCC) and/or high temperature co-fire ceramic (HTCC).

A lower effective resistance (Reff) is achieved with a co-fired hermetic interconnect. Reff is defined as follows:
Reff=ρ_{bult}L/A

where ρ_{bulk} is the bulk resistivity of a pure metal, L is the physical length of the conductor and A is the cross-sectional area of the conductor. Reff for the co-fired metallization is about ten to about one hundred times lower than the Reff for a pure metal. Reduced length and/or the use of multiple conductor pathway allows Reff to be reduced. For example, while a conventional feedthrough pin conductor may be 50-100 mil, co-fired hermetic interconnects (i.e. feedthroughs) may be as small as 20-30 mil. In addition, multiple co-fire feedthrough vias may be electrically connected in parallel to significantly reduce the effective resistance.

Hermetic interconnects can be used in numerous devices. Exemplary devices include IMDs (e.g. implantable cardioverter-defibrillators etc.), electrochemical cells (i.e. batteries and capacitors), and sensors. Sensors can be implanted in a patient's body. Alternatively, the sensor may be applied externally to a patient's body as part of a larger system such as in body networks. Hermetic interconnects can also be used by an in-body sensor to an in-body sensor.

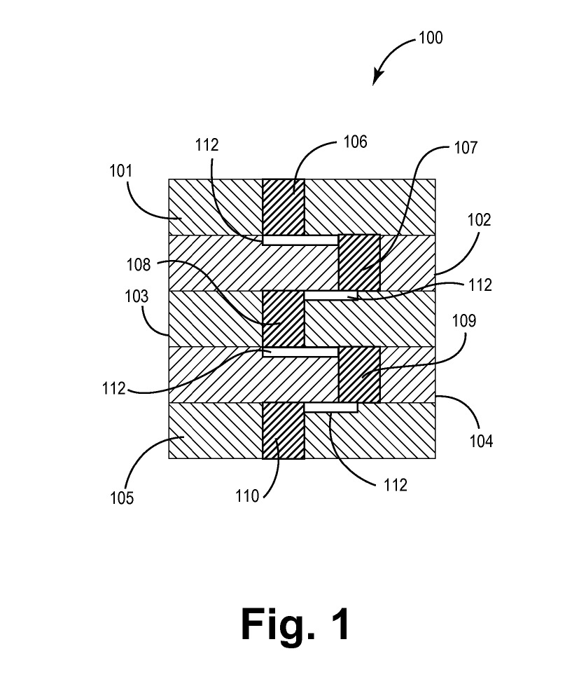

FIG. 1 depicts a co-fired hermetic interconnect 100. Hermetic interconnect includes five layers 101-105 (e.g. ceramic layers such as ceramic green-sheet, etc.), a set of via structures 106-110 with conductive material disposed therein. Conductive material includes at least one conductive metal or alloy. Exemplary conductive metal includes transition metals (e.g. noble metals), rare-earth metals (e.g. actinide metals and lanthanide metals), alkali metals, alkaline-earth metals, and rare metals. Noble metals include copper (Cu), silver (Ag), gold (Au), platinum (Pt), palladium (Pd), niobium (Nb), and iridium (Ir). Exemplary alloys include platinum-gold, platinum-iridium, silver-palladium, gold-palladium or mixtures thereof, tungsten-Mo. Conductive material may be in the form of a paste (e.g. refractory metallic paste, metallic alloy paste, etc.), powder, or other suitable form.

One or more conductive interlayers (or conductive elements) 112 is disposed in between or adjacent opposing via structures. In the depicted embodiment, interlayers 112 have about the same dimension as the corresponding via structure, although different dimensions can be utilized. Interlayer 112 can be formed of the same conductive material as the conductive material disposed in via structures 106-110. In another embodiment, interlayer 112 can be formed of different conductive material than the conductive material disposed in via structures 106-110.

Via structures 106-110 in conjunction with interlayers 112 form a conductive serpentine pathway through hermetic interconnect 100. A serpentine or staggered via geometry increases resistance to fluid ingress compared to a substantially linear geometry. To further enhance the resistance of hermetic interconnect 100 to ingress of fluid, one or more of the interlayer 112 structures can abut one or more adjacent vias or optionally fully or partially overlap an end portion of a via. Moreover, interlayer 112 can have a similar or different surface area in contact with a portion of a via depending on whether a particular region of hermetic interconnect 100 needs to increase electrical communication and/or resist fluid intrusion.

After assembly, hermetic interconnect 100 is sintered or co-fired at an elevated temperature in a chamber of a heater such as a belt furnace. Belt furnaces are commercially available from Centorr located in Nashua, N.H. LTCC temperature ranges from about 650 degrees Celsius (° C.) to about 1300° C. HTCC temperature ranges from about 1100° C. to about 1700° C. At least one or both of the LTCC and HTCC processes are applied to hermetic interconnect 100. During the co-firing process, hermetic interconnect 100 resides in the chamber less than day. After hermetic interconnect 100 has sufficiently cooled, hermetic interconnect 100 is inserted into a ferrule (not shown).

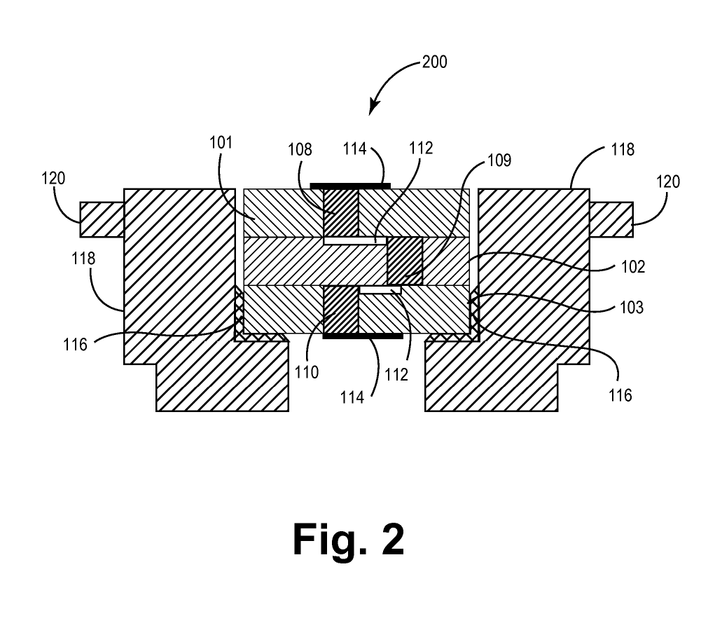

FIG. 2 depicts hermetic interconnect 200 coupled to a ferrule 118. Hermetic interconnect 200 includes three layers 101-103 (e.g., ceramic layers such as ceramic green-sheet layers), interlayers 112, via structures 108-110 with conductive material disposed therein. Interlayer 112 can substantially cover a side of via 108, abut a side portion of a via 109, and partially cover a metallized via (not depicted). The staggered configuration of vias 108-110 increases resistance to fluid ingress to hermetic interconnect 200.

A pair of bonding pads 114 that provide electrical communication to vias 108, 110 are positioned at the exterior of hermetic interconnect 200. In addition to providing a potentially larger bonding surface for connection of remote circuitry, pads 114 increase the resistance of hermetic interconnect 200 to ingress of fluids, such as body fluids. Hermetic interconnect 200 is then inserted into a cavity of a ferrule 118 which in turn is sealingly disposed around an upper periphery of the ferrule 118 within a port of a relatively thin layer of material 120. Material 120 comprises a portion of an enclosure for an IMD, a sensor, an electrochemical cell or other article or component which requires electrical communication. Material 120 can comprise titanium, titanium alloys, tantalum, stainless steel, or other conductive material.

Hermetic interconnect 200 is coupled to a ferrule 118 via a coupling member 116. In one embodiment, coupling member 116 comprises a braze material or equivalent resilient bonding material. Braze material includes a gold (Au) braze or other suitable brazing material. A thin film metal wetting layer is optionally applied to the surface of hermetic interconnect 200 prior to application of the brazing material. Application of thin film wetting layer is described in greater detail in, for example, U.S. Pat. No. 4,678,868 issued to Kraska et al. and U.S. Pat. No. 6,031,710 issued to Wolf et al., the disclosures of which are incorporated by reference in relevant parts.

In another embodiment, coupling member 116 is a diffusion bond formed through a diffusion bonding process that is applied after inserting hermetic interconnect 200 in ferrule 118. Diffusion bonded joints are pliable, strong, and reliable despite exposure to extreme temperatures. Even where joined materials include mis-matched thermal expansion coefficients, diffusion bonded joints maintain their reliability. Additionally, diffusion bonds implement a solid-phase process achieved via atomic migration devoid of macro-deformation of the components being joined.

Prior to undergoing a diffusion bonding process, layers 101-105 should exhibit surface roughness values of less than about 0.4 microns and be cleaned (e.g., in acetone or the like) prior to bonding. The diffusion bonding process variables range from several hours at moderate temperatures (0.6 Tₘ) to minutes at higher temperatures (0.8 Tₘ), with applied pressure (e.g., 3 MNm² and 400° C.). Ceramics allow alloys to be diffusion bonded to themselves and/or to other materials (e.g. metals, etc.).

Diffusion bonding typically occurs in a uniaxial press heated using discrete elements or induction units. Microwave heating may be used to produce excellent diffusion bonds in a matter of minutes, albeit for relatively small components on the order of several inches (e.g., implantable medical devices). It is also possible to produce ceramic-metal diffusion bonds; and, as for ceramic-ceramic diffusion bonding, a combination of time, temperature and pressure are generally required as the metal deforms at the macro level to the ceramic.

When the required temperature has been achieved, a DC voltage of about 100V is applied and the metallic component is held to a positive polarity. The nonmetallic component contains mobile ions (e.g., sodium (Na+)). This process has been successfully applied to glass and ceramics (e.g. beta-alumina). Optionally, diffusion aids or secondary phase materials are present (e.g. glassy phases at grain boundaries).

Numerous articles describe details of the diffusion bonding process that can be applied to the hermetic interconnects. Exemplary articles include N. L. Loh, Y. L. Wu and K. A. Khor, Shear bond strength of nickel/alumina interfaces diffusion bonded by HIP, 37 Journal of Materials Processing Technology, 711-721 (1993); K. Burger and M. Rohle, Material Transport Mechanisms During The Diffusion Bonding Of Niobium To Al₂O₃, 29 Ultramicroscopy 88-97 (1989); M. A. Ashworth, M. H. Jacobs, S. Davies, Basic Mechanisms and Interface Reactions in HIP Diffusion Bonding, 21 Materials and Design 351-358 (2000); A. M. Kliauga, D. Travessa, M. Ferrante, Al₂O₃/Ti interlayer/AISI 304 Diffusion Bonded Joint Microstructural Characterization of the Two Interfaces, 46 Materials Characterization 65-74 (2001), the disclosures of which are incorporated by reference in relevant parts.

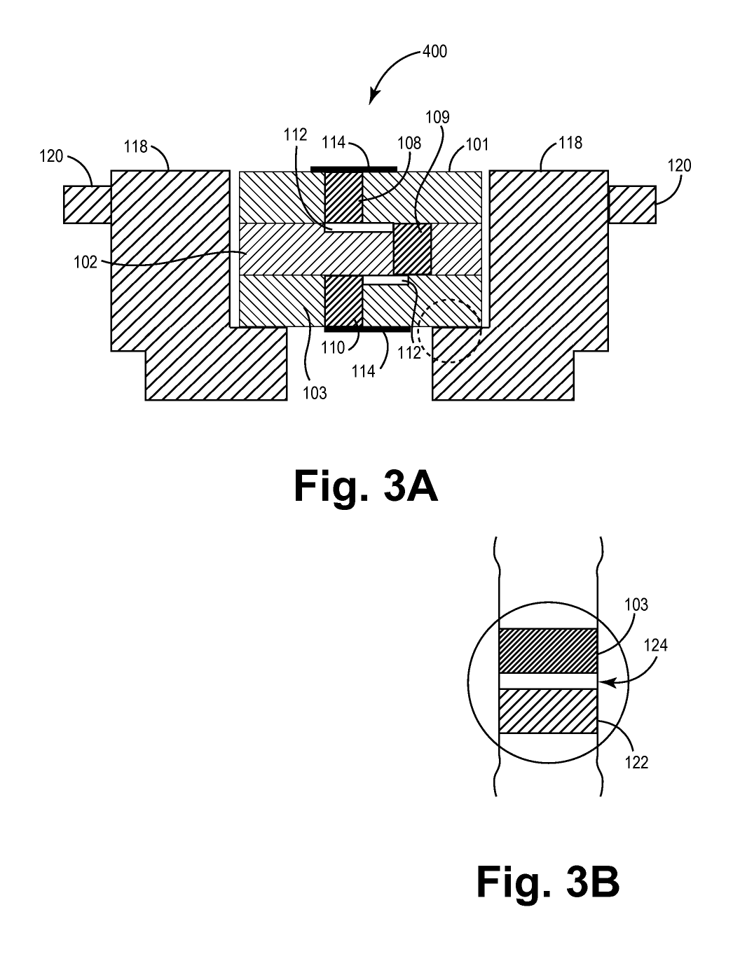

Hermetic interconnect 400 depicted in FIG. 3A and FIG. 3B illustrates the location of a diffusion-bonded region between ferrule 118 and hermetic interconnect 400 (encircled and enlarged in FIG. 3B) as a schematic of a diffusion-bond interlayer 124. As depicted in FIG. 2 (but not in FIG. 3A or 3B), the space or location above ferrule 118 and hermetic interconnect 400 can optionally include a high temperature brazed seal, as previously described.

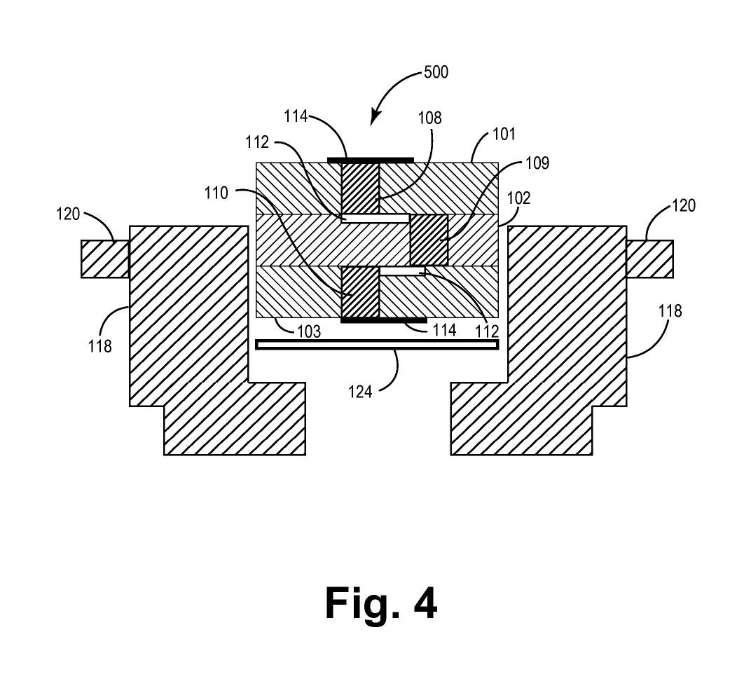

FIG. 4 depicts a co-fired-ceramic hermetic interconnect 500 fabricated using three layers of ceramic green-sheet co-fired to form a monolithic structure with a staggered via structure, with depiction of thin-film reactive material forming interlayer 124. In one embodiment, interlayer 124 comprises a conductive material (e.g. foil material) that is disposed between hermetic interconnect 400 and ferrule 118. In another embodiment, interlayer 124 is introduced as a thin film over ferrule 118 or layer 103.

Interlayer 124 can be formed with an aperture or apertures (not shown) that correspond to one or more capture pads 114 or surface portions of one or more via structures 108,110 disposed on an exterior portion of hermetic interconnect 500. An aperture (not shown) disposed in interlayer 124 prevents electrical contact between interlayer 124 and capture pad 114.

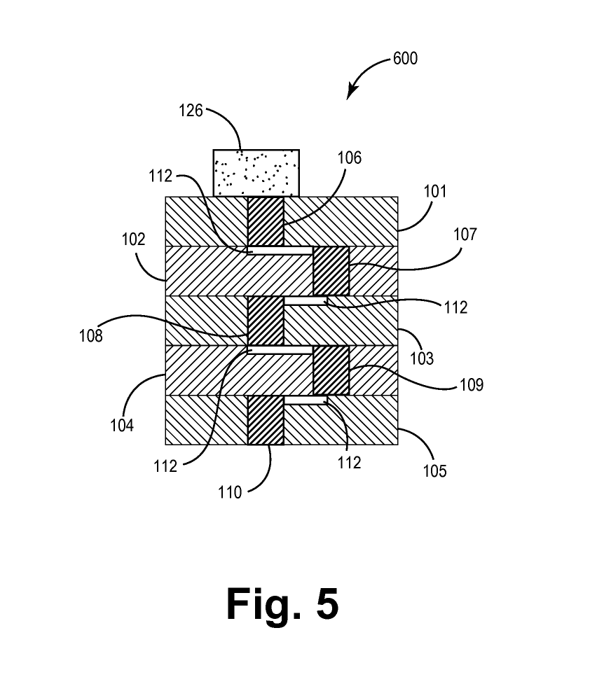

FIG. 5 depicts a co-fired hermetic interconnect 600. Hermetic interconnect 600 includes five layers 101-1 05 (e.g. ceramic layers such as ceramic green-sheet material), via structures 106-110 with conductive material disposed therein. Staggered via structure 106-110 forms a continuous electrical pathway from one side of hermetic interconnect 600 to the other with a diffusion-bonded electrical interconnect structure 126 disposed on a upper surface of the upper layer 101. As depicted, interconnect structure 126 is diffusion bonded to layer 101 and via structure 106.

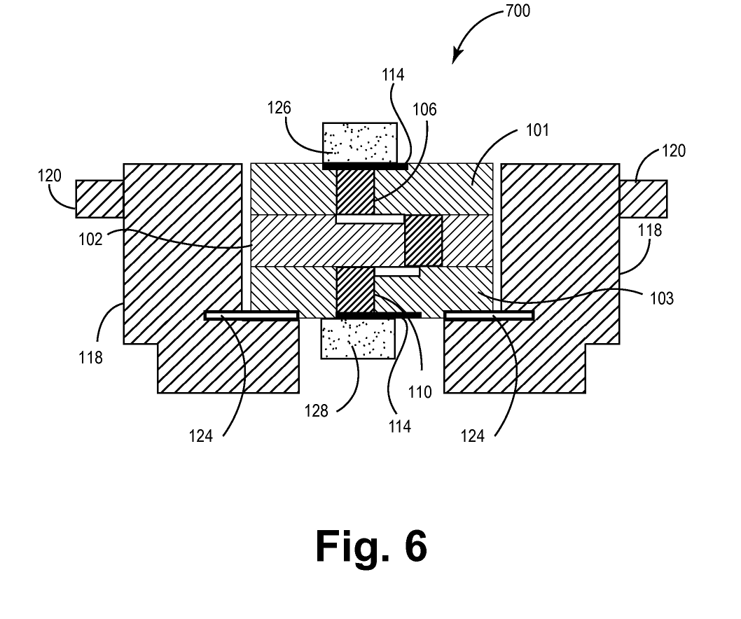

FIG. 6 depicts a hermetic interconnect 700 fabricated using three layers of ceramic green-sheet 101-103 co-fired to form a monolithic structure with a staggered via structure coupled to a ferrule structure 118 using diffusion-bonding techniques. Hermetic interconnect 700 includes electrical interconnect structures 126,128 coupled to via structures 106,110, respectively disposed at opposing sides of hermetic interconnect 700. Electrical interconnect structures 126,128 enhance surface area and mechanical integrity for bonding of conductive elements thereto. Electrical interconnect structures 126,128 can also serve as fiducial alignment posts to aid automated fabrication and/or electrical couplings to hermetic interconnect 700.

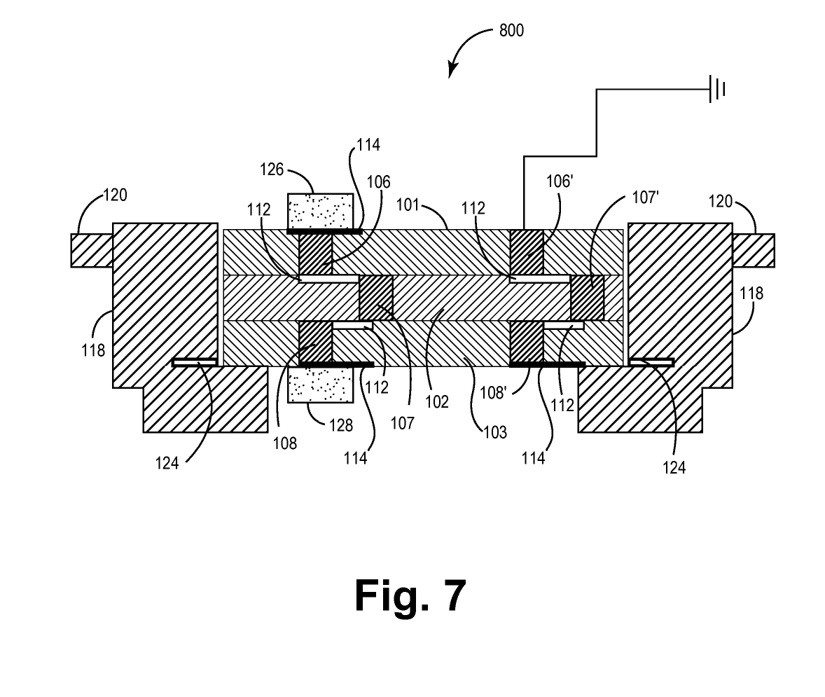

FIG. 7 depicts another embodiment of a hermetic interconnect 800. Hermetic interconnect 800 includes three layers 101-103 (e.g. ceramic green-sheets), a pair of staggered via structures 106-108 and 106′-108′ with conductive material disposed therein. Hermetic interconnect 800 is coupled to ferrule 118 using diffusion-bonding. Electrical interconnecting structures 126,128 are coupled to capture pads 114. Aground connection is coupled to via structure 106′.

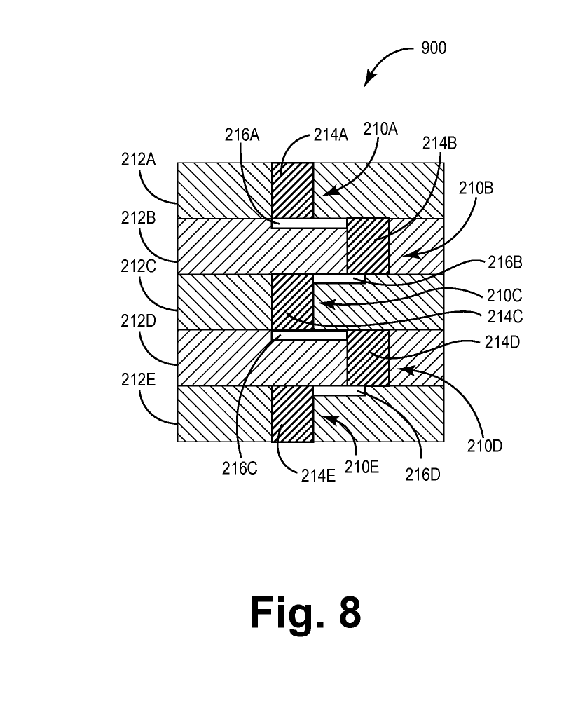

FIG. 8 depicts a cross-sectional view of a hermetic interconnect 900 for an IMD. Hermetic interconnect 900 comprises a set of vias, formed in a set of layers, with a set of conductive elements interconnecting conductive material disposed in the set of vias. Specifically, hermetic interconnect 900 includes first, second, third, fourth, and fifth vias 210A-E, disposed in first, second, third, fourth, and fifth layers 212A-E. Conductive material 214A-E is introduced to first, second, third, fourth, and fifth vias 210A-E. Conductive material 214A-E is any suitable conductive metal. Exemplary conductive material include transition metals (e.g. noble metals (e.g. Cu, Ag, Au, Pt, Pd, Ir, and Nb)), rare-earth metals (e.g. actinide metals and lanthanide metals), alkali metals, alkaline-earth metals, and rare metals, tungsten (W), and/or any suitable combination thereof, Exemplary combinations of conductive material include Pt—Au, Pt—Ir, Ag—Pd, Au—Pd, and W—Mo.

Conductive material 214A-E is interconnected through conductive elements 216A-D. In one embodiment, conductive elements 216A-D comprise the same conductive material. In another embodiment, two of conductive elements 216A-D comprise the same conductive material. In yet another embodiment, three conductive elements 216A-D comprise the same conductive material. In still yet another embodiment, four conductive elements 216A-D comprise the same conductive material. In another embodiment, conductive elements 216A-D each comprise different conductive material.

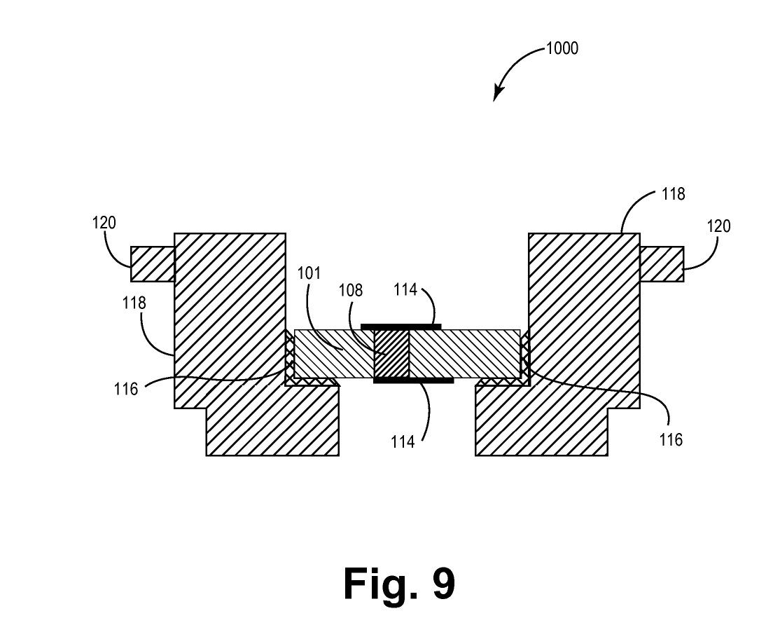

FIG. 9 depicts another embodiment of a hermetic interconnect 1000. Hermetic interconnect 1000 comprises a conductive element 1010 with a pair of bonding pads 114 coupled to a first end 1012A and second end 1012B of the conductive element 1010. Conductive element 1010 is formed by introducing conductive material into a via 1008 disposed in a single layer 101 (e.g. ceramic green-sheet etc.). Conductive material is any suitable conductive metal and/or alloy.

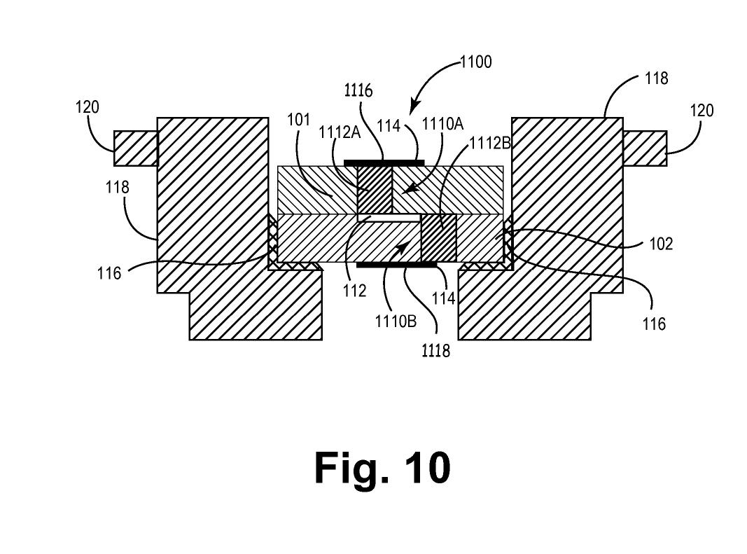

FIG. 10 depicts yet another embodiment of a hermetic interconnect 1100. Hermetic interconnect 1100 comprises conductive elements 111 2A and 1112B, conductive interlayer 112, and a pair of bonding pads 114. Conductive elements 1112A and 1112B comprise any suitable conductive material. Conductive elements 1112A and 1112B are formed by introducing conductive material into vias 1110A and 1110B disposed in layers 101,102, (e.g. ceramic green-sheets etc.), respectively.

Conductive interlayer 112 connects conductive elements 1112A and 1112B. Conductive interlayer 112 comprises any suitable conductive material. Conductive material includes conductive metal(s) and/or conductive alloy(s). Conductive interlayer 112 may comprise the same material as conductive elements 1112A and 1112B. In another embodiment, conductive interlayer 112 may comprise the same material of at least one of conductive elements 1112A and 1112B. In still yet another embodiment, conductive interlayer 112 comprises different material from both of conductive elements 1112A and 1112B. Bonding pads 114 are then coupled to a first and a second end 1116 and 1118 of conductive elements 1112A and 1112B, respectively.

Skilled artisans understand that various dimensions may be used in fabrication of the hermetic interconnects depicted in FIGS. 1-10. Exemplary dimensions for hermetic interconnect 100 include, for example, a single fired layer that possesses a thickness of about 1-20 mils; a via diameter of about 2-20 mils; and a via height that is about the same as the height of a single fired layer. An overall hermetic interconnect possesses dimensions such as a depth of about 10 mils or greater, a width of about 10 mils or greater; and a thickness which is dependent upon the number of layers included in a hermetic interconnect. The thickness of a hermetic interconnect is typically 500 mils.

Although various embodiments of the invention have been described and illustrated with reference to specific embodiments thereof, it is not intended that the invention be limited to such illustrative embodiments. For example, it should be apparent that conductive material in each via may be the same or different from conductive material in another via. Additionally, interlayer 112 may comprise the same or different conductive material as that which is in the vias. Moreover, numerous layers can be used to form a hermetic interconnect. For example, a hermetic interconnect may comprise four layers.

The description of the invention is merely exemplary in nature and, thus, variations that do not depart from the gist of the invention are intended to be within the scope of the invention. Such variations are not to be regarded as a departure from the spirit and scope of the invention.

We claim:

1. A miniaturized hermetic electrical interconnect for an implantable medical device (IMD), comprising:
a monolithic structure derived from at least three discrete ceramic green-state sheet layers with each said at least three ceramic green-state sheet layers having at least one via-receiving aperture coupling major planar sides thereof;
a conductive metallic material disposed within and at least partially filling each of the via-receiving apertures;
a ferrule structure surrounding the monolithic structure, said ferrule structure having an upper surface and a lower surface; and
a structural support member coupled to at least a portion of the lower surface and a lower portion of said monolithic structure,
wherein said monolithic structure and said conductive metallic material are hermetically fused together at elevated temperature,
wherein the coupling between said structural support member and said monolithic structure comprises a diffusion bond.

2. An interconnect according to claim 1, wherein said monolithic structure comprises an insulating dielectric; said insulating dielectric includes at least one of a Al₂O₃, a Al₂O₃—ZrO₂, ZrO₂, SiO₂, aluminum nitride, silicon nitride, silicon carbide, silicon oxynitride, a glass material.

3. The interconnect of claim 2, wherein the SiO₂ being one of amorphous SiO₂ and crystalline SiO₂.

4. An interconnect according to claim 1, wherein the elevated temperature comprises a temperature of between about 650 degrees Celsius (° C.) and 1300° C.

5. An interconnect according to claim 1, wherein the conductive metallic material comprises at least one of platinum, platinum-gold, a platinum-iridium, platinum alloy, tungsten, tungsten-molybdenum, niobium, silver, gold, a silver-palladium, and gold-palladium.

6. An interconnect according to claim 1, wherein the coupling further comprises a braze-metal bond intermediate the ferrule structure and the monolithic structure

7. An interconnect according to claim 1, wherein the braze-metal bond comprises a gold material.

8. An interconnect according to claim 1, further comprising at least one capture pad coupled to the conductive metallic material disposed within one the via-receiving apertures.

9. An interconnect according to claim 1, wherein the via-receiving apertures are disposed in substantially axial alignment.

10. An interconnect according to claim 1, wherein the via-receiving apertures of adjacent green-state sheet layers are offset laterally and further comprising a conductive material coupling said offset via-receiving apertures.

11. An interconnect according to claim 1, wherein said capture pad electrically couples to an electrical circuit producing at least temporarily an electrical voltage-bias signal.

12. An interconnect according to claim 1, wherein said capture pad comprises at least one of: a platinum material, a platinum-gold material, a platinum-iridium material, a platinum alloy material, a tungsten material, a tungsten-molybdenum material, a niobium material, a silver material, a gold material, a silver-palladium material, a gold-palladium material.

13. An interconnect according to claim 1, wherein said capture pad comprises a thin-film structure.

14. An interconnect according to claim 1, wherein said capture pad comprises at least one of niobium, tantalum, titanium, platinum, platinum alloy, gold, gold-palladium, and silver.

15. An interconnect according to claim 1, wherein said capture pad comprises a thick-film metallization ink applied subsequent to the co-firing of the metallic paste and the green-state sheet layers

16. An interconnect according to claim 1, wherein at least one layer of the at least three discrete ceramic green-sheet layers comprises a low temperature co-fire ceramic (LTCC) material.

17. An interconnect according to claim 16, wherein the LTCC material has a melting point between about 850° C. and 1150° C.

18. An interconnect according to claim 1, wherein at least one layer of the at least three discrete ceramic green-sheet layers comprises a high temperature co-fire ceramic (HTCC) material.

19. An interconnect according to claim 18, wherein the HTCC material comprises a refractory conductive material.

20. An interconnect according to claim 19, wherein the HTCC material has a melting point between about 1100° C. and 1700° C.

21. An interconnect according to claim 1, wherein said ferrule structure being at least one of a titanium material, a titanium alloy material, niobium, niobium alloy, and a ceramic oxide material.

22. The interconnect of claim 21 wherein the conductive metallic material comprises a noble metal being one of gold, silver, platinum, palladium, iridium, rhenium, ruthenium, osmium and alloys thereof.

23. The interconnect of claim 1 wherein the conductive metallic material comprises a metal capable of undergoing at least one of a LTCC condition and a HTCC condition.

24. The interconnect of claim 23 wherein the conductive metallic material comprises a metal capable of undergoing at least one of a low fire temperature condition and a high fire temperature condition.

25. The interconnect of claim 24 wherein the low fire temperature ranges from about 850° C. to about 1150° C.

26. The interconnect of claim 23 wherein the high fire temperature ranges from about 1100° C. to about 1700° C.

27. An interconnect according to claim 1, further comprising an aperture formed through a portion of an enclosure, said aperture configured to sealingly receive peripheral edges of the ferrule structure;

28. An interconnect according to claim 1, wherein said enclosure contains an electrochemical cell

29. An interconnect according to claim 28, wherein said electrochemical cell comprises one of: a primary battery, a secondary batter, a capacitor.

30. An interconnect according to claim 1, wherein said enclosure contains at least a part of an IMD.

31. An interconnect according to claim 1, wherein said IMD comprises one of: a pacemaker, a neurological stimulator, a drug pump, a cardioverter-defibrillator, a deep brain stimulator, a medical electrical lead, a physiologic sensor.

32. An interconnect according to claim 31, wherein the physiologic sensor includes one of a sensor adapted to be externally affixed to a patient's body and another sensor implanted in the patient's body.

33. A hermetic interconnect for an IMD, comprising:
a structure derived from at least three discrete ceramic layers with each said at least three ceramic layers having at least one via-receiving aperture coupling major planar sides thereof;
a conductive material disposed within at least one via;
a ferrule structure surrounding the structure, said ferrule structure having an upper surface and a lower surface; and
a structural support member coupled to at least a portion of the lower surface and a lower portion of said structure,
wherein said structure and said conductive material are hermetically fused together.

34. The hermetic interconnect of claim 33 wherein the conductive material being a metal.

35. A hermetic interconnect for an IMD comprising:
a first layer;
a second layer coupled to the first layer;
a third layer;
a first via disposed in the first layer;
a second via formed in the second layer;
a third via formed in the third layer;
a first conductive material disposed in the first via;
a second conductive material disposed in the second via;
a third conductive material in the third via;
a first conductive element coupled to the first and second conductive materials;
a second conductive element coupled to the second and third conductive elements; and
a ferrule surrounding the first, second and third layers.

36. The hermetic interconnect of claim 35 wherein the first, second and third conductive materials being one of a metal and an alloy.

37. The hermetic interconnect of claim 36 wherein the metal comprises at least one of a noble metal, an actinide metal, a lanthanide metal, alkali metal, an alkaline-earth metal, a rare metal, a rare-earth metal, and a transition metal.

38. The hermetic interconnect of claim 37 wherein the first conductive material and the second conductive material are different.

39. The hermetic interconnect of claim 37 wherein the second conductive material and the third conductive material are different.

40. The hermetic interconnect of claim 37 wherein the first second, and third conductive materials are the same.

41. The hermetic interconnect of claim 36 wherein the first conductive element being one of a metal and an alloy.

42. The hermetic interconnect of claim 38 wherein the metal being one of a noble metal, an actinide metal, a lanthanide metal, alkali metal, an alkaline-earth metal, a rare metal, a rare-earth metal, and a transition metal.

43. The hermetic interconnect of claim 35 wherein the first, second, and third layers comprise SiO₂.

44. The hermetic interconnect of claim 35 further comprising:
a fourth layer coupled to third layer, the fourth layer includes a fourth via with a fourth conductive material deposited therein.

45. The hermetic interconnect of claim 44 further comprising:
a fifth layer coupled to fourth layer, the fifth layer includes a fifth via with a fifth conductive material deposited therein.

46. The hermetic interconnect of claim 35 wherein the first and second conductive material comprise at least one of a metal and an alloy.

47. The hermetic interconnect of claim 46 wherein the metal being one of a noble metal, an actinide metal, a lanthanide metal, alkali metal, an alkaline-earth metal, a rare metal, a rare-earth metal, and a transition metal.

48. The hermetic interconnect of claim 47 wherein the first and second conductive material comprise a same metal.

49. The hermetic interconnect of claim 47 wherein the first and second conductive material comprise a different metal.

50. The hermetic interconnect of claim 44 further comprising: a fourth conductive element coupled to the third conductive material and the fourth conductive material.

51. The hermetic interconnect of claim 50 further comprising: a fifth conductive element coupled to the fourth conductive material and the fifth conductive material.

52. A hermetic interconnect for an IMD comprising:
a single layer;
a conductive material coupled to the single layer, the conductive material includes a first end and a second end;
a first bonding pad coupled to the first end of the conductive material; and
a second bonding pad coupled to the second end of the conductive material,
wherein the hermetic interconnect being co-fired.

53. The hermetic interconnect of claim 52 further comprising:
a ferrule coupled to the hermetic interconnect via a diffusion bond.

54. A hermetic interconnect for an IMD comprising:
a first layer with a first via formed therein;
a first conductive material disposed in the first via;
a second layer with a second via formed therein;
a second conductive material disposed in the second via; and
a conductive element coupled to the first conductive material and the second conductive material,
wherein the first and the second layers being co-fired.

55. The hermetic interconnect of claim 46 wherein the conductive element comprises the same conductive material as at least one of the first and the second conductive materials.

56. The hermetic interconnect of claim 46 wherein the conductive element comprises different conductive material from the first and the second conductive elements.

57. The hermetic interconnect of claim 54 further comprising:
a ferrule coupled to the hermetic interconnect via a diffusion bond.
